(19) United States
(12) Patent Application Publication
(10) Pub. No.: US 2011/0268940 A1
(43) Pub. Date: Nov. 3, 2011

(54) Ecological felt pad for furniture legs

(76) Inventors: Marcel Brouard, Pintendre-Levis (CA); Raymond Perron, Pintendre-Levis (CA)

(21) Appl. No.: 12/799,644

(22) Filed: Apr. 29, 2010

(51) Int. Cl. D04H 1/08; B32B 37/00; B32B 37/12; B32B 7/02

(52) U.S. Cl. 428/213; 442/320; 156/60; 156/306.6

(57) ABSTRACT

A felt pad to use under legs of furniture to protect the floor from scratches due to displacement of the furniture. The felt pad comprises two layers joined by an intermediate layer. A first thin layer in contact with the floor comprises virgin fibers, a second thick layer in contact with the bottom of the leg of a piece of furniture comprises recycled material fibers. Both layers are joined together by means of a fusion which forms a thin intermediate layer formed by the fusion of virgin fibers with recycled material fibers, thereby making both layers inseparable one from the other. The use of recycled fibers in bigger quantity than the virgin fibers allows giving a second life to fibers having already served a first time.

### BACKGROUND OF THE INVENTION

1. Domaine De L'Invention

This invention relates to the field of pads to be used under legs of furniture to protect the floor from scratches caused by the movement of the furniture. More particularly, this invention relates to felt pads made with recycled fibers.

2. Prior Art

CN 2841330 “Felt pad with composite layer” of Zhang JINSONG published 2006 Nov. 29; shows a pad comprising a composite layer of Bamboo Carbon which absorbs bad smells.

The present invention refers to a previous invention CA 2,558,716 filed on 2006 Sep. 11 of the same authors, which is a felt pad for furniture legs made by fusion of plastic and felt so that the felt becomes inseparable of the plastic part and remains constantly in contact with the floor.

### OBJECTIVES AND ADVANTAGES

There is a need in the market for products more ecological which could reduce quantities of waste and so protect the environment. The use of recycled products for our invention contributes to give to fibers which were already used a first time, a second life. And all this without damaging the quality of the product, its resistance to shear and its durability.

In the present invention, the first thin layer in contact with the floor is made with virgin fibers and a second thick layer made with recycled fibers coming from fibers of glass, wool, cotton, and more particularly from fibers coming from ripped fabrics or a ripped felt, post consumer or post industrial, or from an extruded fiber from recycled polymer known under the name of regenerated fiber.

This second layer is fixed by means of adhesive at a furniture leg. An intermediate layer localized at a junction of virgin fibers and recycled fibers is the result of the fusion of virgin and recycled fibers.

The present invention will be further understood from the following description with reference to the drawings.

### BRIEF DESCRIPTION OF DRAWINGS FIGURES

FIG. 1 is a cut of an ecological felt pad

### DETAILED DESCRIPTION OF THE PREFERRED EMBODIMENTS

In the following description and in the accompanying drawings, the numeral numbers refer to identical parts in the various Figures.

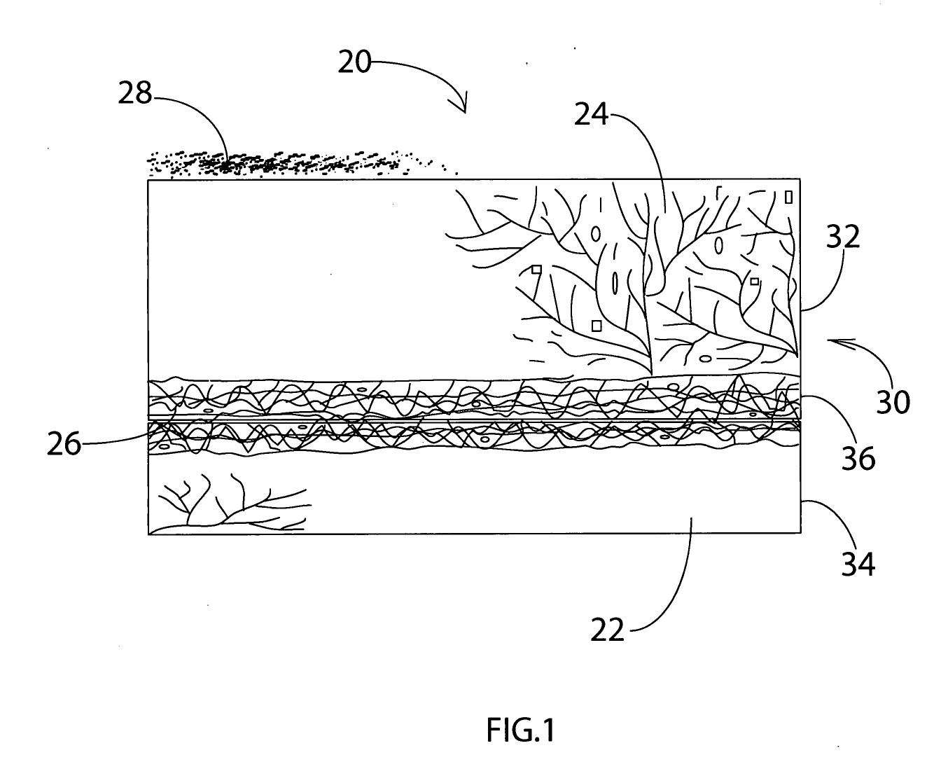

FIG. 1 shows in a cut view a combination 20 composed of a bottom layer made with virgin fibers 22, a top layer made with recycled fibers 24, and at their contact point a fused area 26 made with fused virgin and recycled fibers. To fix the felt pad under a furniture leg an adhesive area 28 is used. On the right side there appears a total thickness 30, a major thickness 32 for recycled fibers, a minor thickness 34 for virgin fibers for contact with a floor and a combined thickness 36 defining a fused zone wherein virgin fibers are shown with recycled fibers and surrounded by amorphous fibers, the original shape thereof having been modified because of the fusion.

### SUMMARY OF THE INVENTION

A felt pad to use under the leg of a piece of furniture composed of two layers joined together by an intermediate layer. A first thin layer 22 in contact with the floor is composed of virgin fibers, a second layer 24 thicker than the first layer and fixed to the leg of a piece of furniture by means of an attachment 28, such as an adhesive band. Both layers are joined together by means of fusion which forms an intermediate layer 26 composed of fused virgin and recycled fibers, this intermediate fused layer 26 making impossible to separate the virgin fiber layer 22 from the recycled fiber layer 24. If recycled fibers were used in bigger quantity than virgin fibers it would avoid wasting of fibers having already served a first time by giving them a new utility. Respective quantities of the components according to their thicknesses is as follows: a minor thickness 34 corresponds to a density of fibers to support a load on a floor by taking into account the roughness of the floor. For example for a roughness of floor “r”=1 mm, the minor thickness 34 would be of 3 mm. Thereby, the minor thickness, of virgin fibers, possesses a recognized aesthetic appearance by consumers. The second layer 24 may be strengthened by means of latex injection. It is to be clearly understood that the instant description with reference to the annexed drawing is made in an indicative manner and that the preferred embodiments described herein are meant in no way to limit further embodiments realizable within the scope of the invention. The matter which is claimed as being inventive and new is limited only by the following claims.

### PARTS

20 Combination
22 Virgin fiber bottom layer
24 Recycled fiber top layer
26 Intermediate fused layer
28 Means of attachment
30 Total thickness
32 Major thickness
34 Minor thickness
36 Combined thickness

I claim:

1. A combination (20) of virgin and recycled fibers intended to serve under an object to protect a surface, said combination comprising:
a layer of recycled fibers (24) comprising means of attachment to said object,
a layer of virgin fibers (22) comprising means to slide on said surface,
means of junction between said recycled fibers and said virgin fibers to resist shear stress.

2. The combination of claim 1 wherein said means of junction between said recycled fiber layer (24) and said virgin fiber layer (22) is a fusion resulting in a fused area (26).

3. A felt pad for a furniture leg using recycled materials with the aim of giving a second life to already used materials and comprising:
a layer of recycled fibers (24) comprising means of attachment (28) to said leg and defining a major thickness (32);
a layer of virgin fibers (22) comprising means to slide on a surface and defining a minor thickness (34);
an intermediate layer defining a fused area of combined thickness (36) wherein virgin fibers are present with recycled fibers and surrounded by amorphous fibers, the original form thereof having been modified because of a fusion, said fused area extending along a combined thickness (36) and strongly unifying said recycled and said virgin fibers to resist shear stress and avoid their separation.

4. The combination of claim 1 wherein said recycled fiber layer (24) has a thickness two to five times as large as a thickness of said virgin fibers.

5. A process of fabrication of a combination (20) of virgin fibers and recycled fibers comprising the following steps:
choosing a layer of recycled fibers (24) comprising means of attachment to a furniture leg;
choosing a layer of virgin fibers (22) comprising in its inferior face means to slide on a surface;
fusing said layers by keeping a depth of said recycled fibers equal to at least double of a depth of said virgin fibers.

6. The combination of claim 1 wherein said means of junction comprise an adhesive film wherein a first side is intended to join said recycled fiber layer and a second side is intended to join said virgin fiber layer.

7. The combination of claim 4 wherein said recycled fiber layer (24) has a thickness four times as large as a thickness of said virgin fibers.
